(19) United States
(12) Patent Application Publication
(10) Pub. No.: US 2016/0180378 A1
(43) Pub. Date: Jun. 23, 2016

(54) CONTENT REPRODUCTION SYSTEM INCLUDING REPRODUCTION UNIT REPRODUCING CONTENT RELATED TO COMMODITIES, CONTENT REPRODUCTION METHOD, AND STORAGE MEDIUM STORING PROGRAM

(71) Applicant: CASIO COMPUTER CO., LTD., Tokyo (JP)

(72) Inventors: Toshihiko YOSHIDA, Fussa-shi (JP); Kazuma KAWAHARA, Akishima-shi (JP); Kazuto YAMAMOTO, Akishima-shi (JP); Chihiro TOYAMA, Hachioji-shi (JP)

(73) Assignee: CASIO COMPUTER CO., LTD., Tokyo (JP)

(21) Appl. No.: 14/942,867

(22) Filed: Nov. 16, 2015

(30) Foreign Application Priority Data
Dec. 19, 2014 (JP) 2014-257858

(51) Int. Cl. G06Q 30/02; G06Q 20/20

(52) U.S. Cl. CPC G06Q 30/0254; G06Q 20/203

(57) ABSTRACT

A content reproduction system includes a reproduction unit configured to reproduce content related to a plurality of commodities, an obtaining unit configured to obtain a sales condition corresponding to the plurality of commodities, a setting unit configured to previously set sales targets and weighting information, related to reproduction in the reproduction unit, with respect to the plurality of commodities, and a control unit configured to variably adjust a reproduction state of the content, related to the plurality of commodities to be reproduced by the reproduction unit, in accordance with the sales target and the weighting information set by the setting unit and the sales condition obtained by the obtaining unit.

### CROSS-REFERENCE TO RELATED APPLICATIONS

This application is based upon and claims the benefit of priority from Japanese Patent Application No 2014-257858, filed Dec. 19, 2014, the entire contents of which are incorporated herein by reference.

### BACKGROUND OF THE INVENTION

1. Field of the Invention

The present invention relates to a content reproduction system including a reproduction unit which reproduces content related to a plurality of commodities, a content reproduction method, and a storage medium which stores a program.

2. Description of the Related Art

Jpn. Pat. Appln. KOKAI Publication No, 2000-020606 proposes a technique related to a storefront information distribution system and a storefront information distribution apparatus in a distribution business which can create storefront information matched with display means specified by individual counters and stores, using a point of sales (POS) terminal.

In the technique described in Jpn. Pat. Appln. KOKAI Publication No. 2000-020606, a management unit connected to a counter through a network evaluates sales information transferred from the counter and creates storefront information based on the evaluation of the sales information, and the storefront information is displayed by display means of specific terminal equipment at the counter.

Examples of concrete contents of the storefront information include introduction of leading products according to a time zone and information on discounts on daily dishes. However, in an actual management unit, a human being as an operator who operates the management unit processes classifications and statistics of products whose sales have increased and, in addition to this, executes this type of processing in which a specific logic for determining, for example, discount prices of daily dishes or leading products is not described. Thus, it cannot be said that creation of storefront information is automated without human intervention.

Accordingly, it is an object of the present invention to provide a content reproduction system, content reproduction method, and a program, capable of automatically variably setting a reproduction state in accordance with actual sales conditions when a plurality of content data such as data for sales promotion are reproduced.

### BRIEF SUMMARY OF THE INVENTION

According to one aspect of the present invention, there is provided a content reproduction system comprising: a reproduction unit configured to reproduce content related to a plurality of commodities; an obtaining unit configured to obtain a sales condition corresponding to the plurality of commodities; a setting unit configured to previously set sales targets and weighting information, related to reproduction in the reproduction unit, with respect to the plurality of commodities; and a control unit configured to vary a reproduction state of the content, related to the plurality of commodities to be reproduced by the reproduction unit, in accordance with the sales target and the weighting information set by the setting unit and the sales condition obtained by the obtaining unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a configuration of an in-store advertisement presentation system according to an embodiment of the present invention;

FIG. 2 is a block diagram showing a functional circuit configuration of a signage device according to the embodiment; and

FIG. 3 is a flowchart showing processing content related to reproduction of content data in the signage device to be executed by a POS terminal serving as a host according to the embodiment.

### DETAILED DESCRIPTION OF THE INVENTION

Hereinafter, an embodiment in which the present invention is applied to an advertisement presentation system used in a store will be described with reference to the drawings.

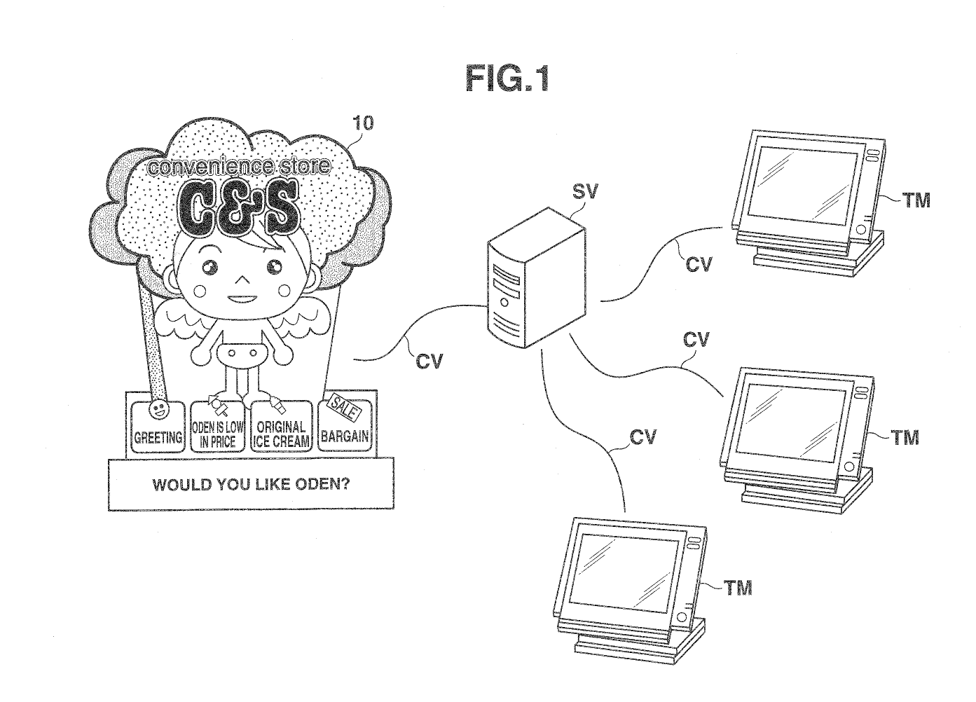

FIG. 1 is a view showing a connection configuration of the entire advertisement presentation system. A plurality of POS terminals TM which perform accounting processing when a commodity is purchased and a signage device 10 which reproduces content including images and/or sounds of commodities or the like are cable-connected to a sales management server SV through cables CV to form a star type local area network (LAN).

The signage device 10 is a projector type electronic mannequin which projects an image on an amorphous screen panel from the back side and projects an image on the screen panel and outputs sounds using a speaker based on content data stored in an internal memory.

The sales management server SV is installed so as to grasp sales conditions in the store and stores and manages the sales conditions such as a target sales number of commodities, a reproduction time per one reproduction of content data corresponding to each commodity to be reproduced by the signage device 10, the sales number of each commodity input from the POS terminals TM, and a sales amount.

The POS terminals TM have a cash register function. The POS terminals TM perform accounting processing when a customer who has come to a store purchases a commodity, and simultaneously, notifies the sales management server SV of sales information on the commodity. The sales condition may be input by someone through an input unit or may be obtained by an obtaining unit from a server storing the sales conditions counted by an operator.

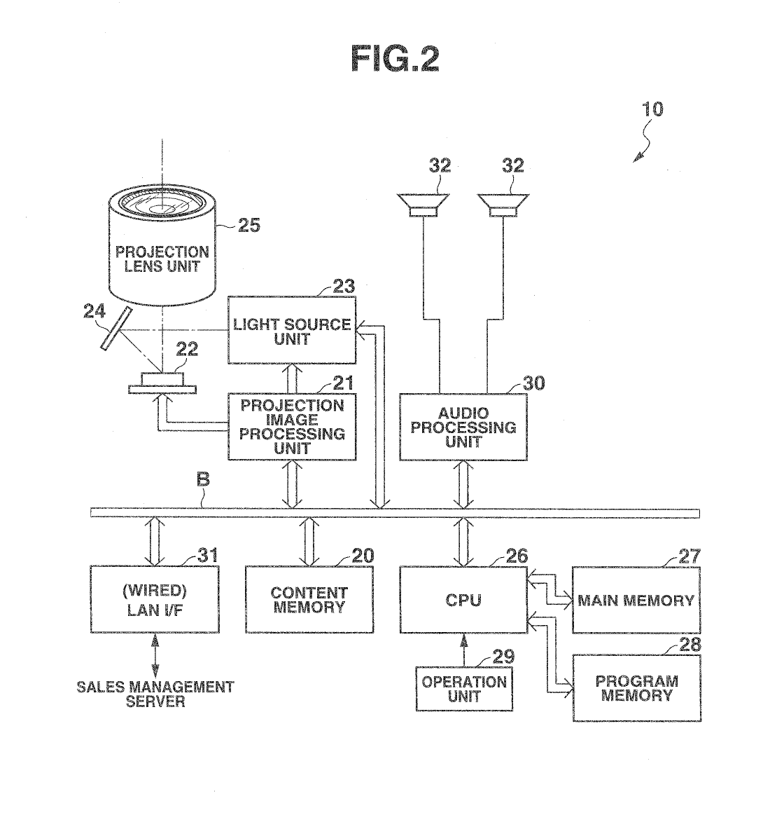

Next, a functional configuration of an electronic circuit as a main part of the signage device 10 will be described with reference to FIG. 2. In FIG. 2, a content memory 20 previously stores content data corresponding to many commodities sold at the store. Image data in the content data selected and read out from the content memory 20 is sent to a projection image processing unit 21 through a bus B.

According to image data received, the projection image processing unit 21 display-drives a micromirror element 22, which is a display element, by higher time-division drive obtained by multiplication of a frame rate following a predetermined format, for example, 120 frames/second, division number of a color component, and the number of display gradations.

The micromirror element 22 individually subjects inclination angles of a plurality of minute mirrors arranged in an array form to on/off operations at a high speed to carry out a display operation, thereby forming a light figure by the reflection light from the minute mirrors.

The light source unit 23 emits R, G, B primary color lights in time division cyclically. The light source unit 23 has an LED as a semiconductor light emitting device and repeatedly emits R, G, and B primary color lights in time division. The LED of the light source unit 23 may include an LD (semiconductor laser) and an organic EL element as the LED in a broad sense. The primary color lights from the light source unit 23 are reflected by a mirror 24 and casted on the micromirror element 22.

Then, the reflected light from the micromirror element 22 forms an optical image. The formed optical image passes through a projection lens unit 25 and is projected onto a screen panel (not shown).

Audio data in content data read out from the content memory 20 is sent to an audio processing unit 30 through the bus B. The audio processing unit 30 has a sound source circuit such as a PCM sound source, reproduces an analog audio signal based on the sent audio data, and causes speaker units 32 to emit sound.

A CPU 26 controls all operations of each of the above circuits. The CPU 26 is connected directly to a main memory 27 and a program memory 28. The main memory 27 is constituted of an SRAM, for example, and functions as a work memory of the CPU 26. The program memory 28 is constituted of an electrically rewritable nonvolatile memory, such as a flash ROM, and stores therein an operation program to be executed by the CPU 26, various standardized data items, and the like.

The CPU 26 reads the operation program, standardized data, and the like stored in the program memory 28, develops and stores the read program, data, and the like in the main memory 27, and executes the program to thereby perform overall control on the signage device 10.

The CPU 26 carries out various projection operations in accordance with an operation signal from an operation unit 29. The operation unit 29 sends, to the CPU 26, a key operation signal of a key provided in a main body of the signage device 10 and operated directly by a customer.

The CPU 26 is further connected to a LAN interface (I/F) 31 through the bus B.

The LAN interface 31 sends and receives data to and from the sales management server SV through the cable CV.

Since the configurations themselves of the sales management server SV and hardware circuits of the POS terminals TM are well-known techniques, an illustration and description thereof are omitted.

Next, the operation of the above embodiment will be described.

In this embodiment, for example, when one of the POS terminals TM serves as a host, the signage device 10 causes the POS terminal TM to execute a control operation in reproduction of content data.

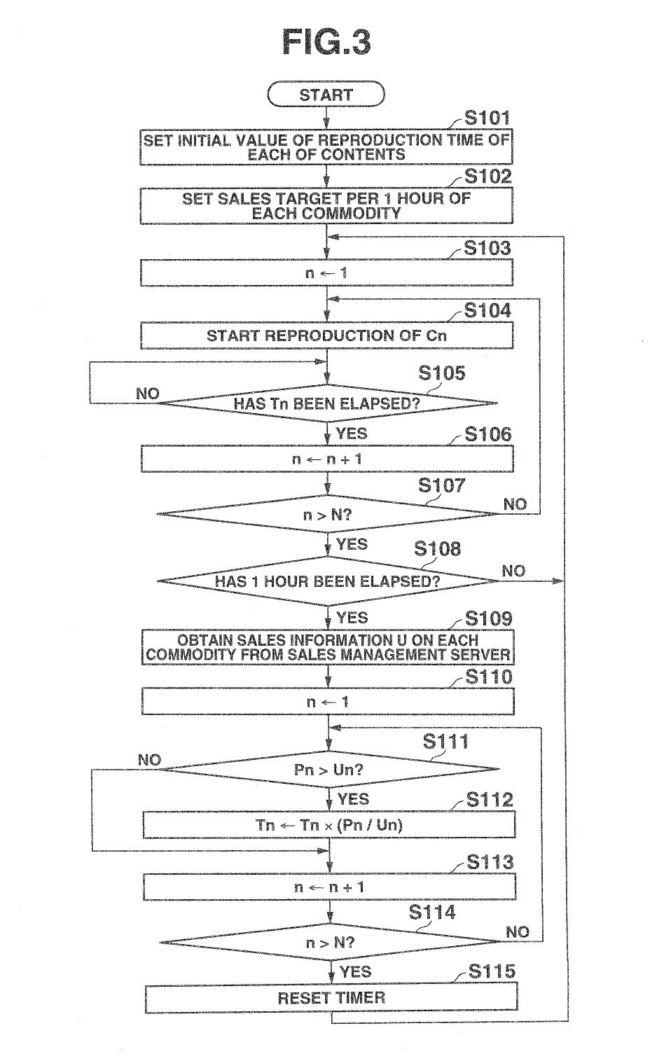

FIG. 3 is a flowchart showing processing content related to reproduction of content data in the signage device 10 to be executed by the POS terminal TM serving as a host.

At the beginning of the processing, in the POS terminal TM, initial values of reproduction times of a plurality of content data reproduced by the signage device 10 are set (step S101).

In this processing, for example, when the content data related to a total of four commodities is reproduced by the signage device 10, reproduction times T1 to T4 of content data C1 to C4 stored in the content memory 20 of the signage device 10 are set so that:

T1=60 (seconds),

T2=30 (seconds),

T3=20 (seconds), and

T4=10 (seconds).

Subsequently, the POS terminal TM sets a sales target for each commodity in a unit time, such as one hour, in the store (step S102).

Sales targets P1 to 94 of those four commodities are set so that:

P1=600 (the number of commodities),

P2=300 (the number of commodities),

P3=200 (the number of commodities), and

P4=100 (the number of commodities).

After setting of the sales targets, in order to immediately start reproduction of the content data in. the signage device 10, the POS terminal TM as a host substitutes an initial value “1” into a variable n designating content data (step S103) and then starts reproduction of content On (for example, C1) in the signage device 10 (step S104).

The POS terminal TM as a host simultaneously counts the reproduction time of the content data and repeatedly determines whether the reproduction time of the content data has reached a content reproduction time Tn (for example, T1) set in step S101 (No in step S105), thereby waiting for an elapse of the time Tn.

After that, once it is determined that the reproduction time of the content Cn has reached Tn and a time set at that point of time (Yes in step S105), the variable n is then updated and set by “+1” (step S106).

Here, whether a value of the updated and set variable n is more than a total number N (for example, 4) of content data set to be reproduced is determined (step S107). When it is determined that the value of the updated and set variable n is less than the total number N of the content data (No in step S107), the flow is returned to the processing starting from step S103, and the next content data is reproduced by the signage device 10 by the time set at that point in time based on the value of the updated and set variable n.

After the content data C1 to C4 are thus reproduced in sequence in accordance with the times T1 to t4 set at those points of time, when the variable n is further updated and set by “+1” to be set to “5” in step S106, it is determined that the value of the variable n updated and set in the subsequent step S107 is more than the total number N of the content data (Yes in step S107). Then, after the reproduction of the above content data is started, it is determined whether one hour as a unit time has elapsed (step S108).

When it is determined that one hour has not elapsed yet (No in step S108), the flow is returned to the processing starting from step S103, and the reproduction from the first content data C1 is started.

The processing from steps S103 to S108 is thus executed in sequence, and the processing for reproducing in sequence the content data C1 to C4 by the signage device 10 in accordance with the times T1 to T4 set at those points of time is executed several times. After that, when it is determined that the content reproduction time has passed one hour in step S108 (Yes in step S108), the POS terminal TM obtains the sales numbers U1 to U4 of the four commodities per the latest one hour from the sales management server SV at that point of time (step S109).

Subsequently, an initial value “1” is substituted into the variable n (step S110), and then it is determined whether the sales target is not achieved depending on whether a target sales number Pn (for example, P1) of commodities is more than an actual, sales number Un (for example, U1) (step S111).

Here, the target sales number Pn of commodities is more than the actual sales number Un, and only when it is determined that the sales target is not achieved (Yes in step S111), the POS terminal TM executes calculation where the content reproduction time Tn is extended in accordance with a ratio of the actual sales number Un and the target sales number Pn, using an arithmetic-expression: Tn×(Pn/Un), and this result is updated and set as a new content reproduction time Tn (step S112).

For example, when the actual sales number U1=500 with respect to the first commodity sales target P1=600, 60×(600/500)=72 based on the above arithmetic expression, and 72 seconds is set as a new content reproduction time T1.

Meanwhile, the target sales number Pn of commodities is not more than the actual sales number Un in step S111, and when it is determined that the sales target has been achieved (No in step S111), the updating and setting of the content reproduction time Tn using the calculation in step S112 is not performed.

After that, the variable n is updated and set by “+1” (step S113). It is determined that a value of the updated and set variable n is more than the total number N (for example, 4) of content data set to be reproduced (step S114). When it is determined that the value of the updated and set variable n is less than the total number N of content data (No in step S114), the flow is returned to the processing starting from step S111.

When the processing from steps S111 to S114 are thus repeatedly executed, if among the respective actual sales numbers U1 to U4 of the commodities 1 to 4, there is an actual sales number which does not achieve the target sales number (P1 to P4), setting processing is executed so that the content reproduction time is extended in accordance with a ratio.

After termination of setting processing of the content reproduction times corresponding to the commodities 1 to 4, when it is determined that the value of the variable n updated and set in step S114 is more than the total number N of the content data (Yes in step S114), a timer which counts an elapse of one hour as a unit time is reset (step S115), and in order to start reproduction of content data again, the flow is returned to the processing starting from step S103,

In the above example of operation, it is described that the target sales number Pn of commodities is more than the actual sales number Un, and when it is determined that a sales target is not achieved, the content reproduction time Tn is extended in accordance with the ratio of the actual sales number Un and the target sales number Pn. However, on the other hand, the actual sales number Un is more than the target sales number Pn of commodities, and when it is determined that a sales target has been achieved, the content reproduction time Tn of content data corresponding to the commodity may be extended for promotion so that the sales further increase.

In the above example of the operation, the target sales number Pn of commodities and the actual sales number Un are compared, and the content reproduction time Tn is changed in accordance with this ratio. However, the amount may be compared instead of the number. Specifically, a target sales amount per unit time and an actual sales amount per unit time are compared, and the content reproduction time Tn may be changed in accordance with whether the target sales amount has been achieved.

In the above embodiment, in the LAN-connected system. configuration, one of the POS terminals TM serves as a host, and the content data to be reproduced by the signage device 10 is controlled. However, the sales management server SV may serve as a host.

Alternatively, the signage device 10 itself which reproduces content data may serve as a host and execute the processing contents shown in FIG. 3 while sending and receiving data to and from the sales management server SV.

As described above in detail, according to the present embodiment, when a plurality of content data such as data for sales promotion are reproduced, a reproduction state can be automatically variably set in accordance with actual sales conditions.

In the above embodiment, the numbers of a plurality of commodities are set as sales targets, and the reproduction times of content data related to the commodities are suitably reset in accordance with the actual sales numbers. Therefore, content data for sales promotion precisely reflecting actual sales conditions can be reproduced without human intervention.

In the above embodiment, although the reproduction time of content data is suitably extended, the content data has a fixed length, as in moving picture data, for example, and if it is difficult to perform reproduction processing in which extension is performed in percent units, for example, adjustment may be performed by the number of times of reproduction per unit time without increasing or reducing one reproduction time, whereby a processing load on a reproduction system circuit can be reduced.

In addition, a plurality of versions of content data with different reproduction times are provided with respect to the same commodity, and necessary content data is selected from the different versions of content data in accordance with the length of the reproduction time, whereby even for content data, such as moving image data, in which it is difficult to adjust an arbitrary time, it is possible to suitably correspond to the content data and realize more detailed control.

In the above embodiment, although the example in which a digital light processing (DLP)® type projector optical image is provided as the signage device 10 to reproduce content data is described, the present invention is not limited to a configuration and so on of a device which reproduces content data.

Moreover, the present invention is not limited to the embodiments described previously, and can be variously modified in the implementation stage within the scope not deviating from the gist of the invention. Further, the functions to be carried out in the above-mentioned embodiments may be appropriately combined within the limits of the possibility of implementation. Various stages are included in the embodiments described above, and by appropriately combining a plurality of constituent elements, various inventions can be extracted. For example, even when some constituent elements are deleted from all the constituent elements shown in the embodiments, if an advantage can be obtained, the configuration from which the constituent elements are deleted can be extracted as an invention.

What is claimed is:

1. A content reproduction system comprising:
a reproduction unit configured to reproduce content related to a plurality of commodities;
an obtaining unit configured to obtain a sales condition corresponding to the plurality of commodities;
a setting unit configured to previously set sales targets and weighting information, related to reproduction in the reproduction unit, with respect to the plurality of commodities; and
a control unit configured to variably adjust a reproduction state of the content, related to the plurality of commodities to be reproduced by the reproduction unit, in accordance with the sales target and the weighting information set by the setting unit and the sales condition obtained by the obtaining unit.

2. The content reproduction system according to claim 1, wherein the data is content including at least one of image data and audio data, and the setting unit sets the number or amount as the sales target with respect to the plurality of commodities and a reproduction time of the content related to the plurality of commodities as the weighting information.

3. The content reproduction system according to claim 2, wherein the control unit adjusts the reproduction time of the content related to the plurality of commodities to be reproduced by the reproduction unit by the number of times of reproduction per unit time.

4. The content reproduction system according to claim 2, wherein the reproduction unit selectively reproduces one of a plurality of versions of contents with different reproduction times related to the same commodity, and the control unit selects one of the plurality of versions of contents and reproduces the selected content in accordance with the reproduction time of the content related to the plurality of commodities to be reproduced by the reproduction unit.

5. A content reproduction method applied to an apparatus including a reproduction unit which reproduces content related to a plurality of commodities, the content reproduction method comprising:
obtaining a sales condition corresponding to the plurality of commodities;
previously setting sales targets and weighting information, related to reproduction in the reproduction unit, with respect to the plurality of commodities; and
variably adjusting a reproduction state of the content, related to the plurality of commodities to be reproduced by the reproduction unit, in accordance with the sales target and the weighting information set in the setting and the sales condition obtained in the obtaining.

6. A non-transitory computer-readable storage medium having a program stored thereon which controls a computer with a built-in device including a reproduction unit which reproduces content related to a plurality of commodities, to perform functions comprising:
an obtaining unit configured to obtain a sales condition corresponding to the plurality of commodities;
a setting unit configured to previously set sales targets and weighting information, related to reproduction in the reproduction unit, with respect to the plurality of commodities; and
a control unit configured to variably adjust a reproduction state of the content, related to the plurality of commodities to be reproduced by the reproduction unit, in accordance with the sales target and the weighting information set by the setting unit and the sales condition obtained by the obtaining unit.
